(19) United States
(12) Patent Application Publication
(10) Pub. No.: US 2019/0359386 A1
(43) Pub. Date: Nov. 28, 2019

(54) DISPOSABLE LINER CONTAINER FOR WAX-WARMER

(71) Applicant: Siva Jakilinki, Dallas, TX (US)

(72) Inventor: Siva Jakilinki, Dallas, TX (US)

(21) Appl. No.: 15/985,799

(22) Filed: May 22, 2018

(51) Int. Cl. B65D 25/14; H05B 3/68

(52) U.S. Cl. CPC B65D 25/14; H05B 2203/028; H05B 3/681

(57) ABSTRACT

The present invention discloses a disposable liner container for wax melt dish of the wax warmer that makes disposing of melted wax easy and mess free and also without any risk of burns to the user. The liner container of present invention comprises a circular flat base plate and an upstanding side walls inclined outwardly from the base plate all around the circumference of the base plate with an outwardly extending rim at the edges of the walls. Moreover, it comprises of a pair of the wings/extensions extending out from either sides of the liner from the edges of the side walls that enables user to hold and dispose the hot melted wax from the dish quickly without any harm or burns. Furthermore, the liner container is made of metal, most preferably, but not limited to, a foil of an aluminium and resembles/mimics the size and shape of the dish of the wax warmer. Most preferably, the shape of the liner container is cylindrical but can be selected according to the shape of the dish and the size of the liner is preferably selected slight smaller than the dish of the warmer for better placement.

### FIELD OF THE INVENTION

The present invention is a wax melt discard dish for wax warmers. More particularly, it is a liner container for a wax warmer that eliminates the need to clean the wax warmer after each use. Additionally, it enables disposal of hot molten wax quickly without any risk of harm so that the warmer may be reused immediately.

### BACKGROUND OF THE INVENTION

Scented Wax candles have been used for a long time for the purpose of illumination, decoration as well as for removal/masking of any unpleasant odour and to spread fragrance in houses, offices, restaurants, hotels and also in aromatherapies, etc. Conventional candles use wicks to burn the wax which produces soot as the wick burns, as a result, there is a burnt smell after the candle extinguishes. Furthermore, regular candles burn through the middle, leaving a lot of leftover wax after the wick has burnt completely and forces the user to throw away the leftover, in addition to the bottom part of the expensive candle.

Moreover, the main issue with the regular wicked candles is the safety as a person cannot head-out leaving them unattended. Further, one has to take additional care to avoid accidental injuries to minors and the inept/heavy handed persons.

To overcome such problems associated with the regular wick candles, numerous attempts have been made. The most popular solution that came out was a wax warmer which is a warming device that melts scented wax to release fragrance. A wax warmer can be electrical or non-electrical device which uses a dish to contain the solid wax. The wax is melted by heating the said dish of the warmer, thus spreading the scent in a room or around the environment where it is placed.

One such candle warmer is disclosed in a U.S. Pat. No. 7,132,084 B1. It is a scent dispersion system, comprising of a heating device having a top surface, and a glass jar of scented wax disposed upon a top surface of the heating device. Upon heating, scent from the wax is caused to disperse into the surrounding environment. It further includes a fan associated with the device, to help disperse the scent from the melted wax.

Furthermore, U.S. Pat. No. 7,067,772 B2 discloses a candle warming apparatus that is adapted to warm a candle or other object resting thereon, as well as to provide illumination that simulates the effects of a lighted burning candle. It further comprises a blower to facilitate heating of a candle placed thereon, as well as to causes scented particles emanating from the melted wax or wax like substance to be better dispersed or dissipated into the surrounding air.

But the main problem with above-mentioned wax warmer is the disposal of the melted wax after the use. The scented wax when melted, acquires liquid state and the user then has to shut off the warmer and wait until the wax gets hard enough so that the user can push it out using tools or pop out from the dish of the wax warmer. But this further results in a residue left behind almost every time, which is tedious to scrape-off from the dish of the warmer. Additionally, the conventional dishes are often difficult to handle due to the heat and melted hot wax in it.

Moreover, in traditional dish of the wax warmer, when the emission of scent from the wax is over, even though the wax remains in the dish, the user needs to remove that old wax from the dish to use the dish with new wax cube. For doing this, if the user attempts to clean out the old wax while it is melted then it is possible that the user may spill the melted hot wax that can cause harm. While on the other hand, if the user waits for the wax to get hard, then it can become more difficult and tedious task for the user to remove wax from the dish of the wax warmer. Removing re-solidified wax melt is not a smooth process, and is dependent on the following factors:
smoothness of the wax warmer dish—Any scratches or undulations on the wax warmer dish surface causes the re-solidified wax melt to stick to the dish;
Quality of wax can affect the smooth removal of the re-solidified wax. Sticky wax can prove difficult removal.
   Due to the aforesaid, the user does not have any alternative to quickly discard the melted wax so that the dish may be reused immediately.

For the foregoing reasons, there is a need of an article that allows user to quickly dispose the melted wax from the dish of the wax warmer so the dish can be re-used immediately. Furthermore, there is a need of an article that can eliminate the need to clean the dish of the wax warmer after every use which is tedious and unpleasant task. There is also a need of an article that allow user to discard the used wax from the dish without any trouble due to the state of the wax whether it is melted or solidified.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended to determine the scope of the claimed subject matter.

One version of the invention, disclosed herein, addresses the above-mentioned need of an article or simply a container, which can be used to dispose the melted and collected wax from the wax warmer used for fragrance. Furthermore, the invention discloses a liner container that enable users to dispose the melted wax from the dish without a mess and without the risk of burns.

According to the present invention, it discloses a liner container that can be made of a thin foil of a metal such as aluminium, copper, tin, steel or polymer etc. The liner container is capable of being positioned on the dish of the wax warmer to eliminate the need of placing the scented wax, tarts or the cubes which are to be melted for spreading fragrance, directly on the dish of the wax warmer. Thus instead of using dish of the wax warmer directly for melting purpose which then becomes tedious task for the user to clean the dish for immediate re-use, it provides an alternative that can be placed on the dish of the wax warmer to hold the wax cubes as well as melted wax. Moreover, said liner container is disposable but also can be re-used for few times, if desired.

According to an embodiment of the present invention, The liner container that is most preferably, but not limited to, cylindrical shaped container made of foil of metal which comprises: a flat base, an outwardly inclined side walls extending from the edge of the base all around the circumference of the base plate making a container like structure that can hold any object regardless of its state whether solid or liquid state without leakage, and a pair of the wings/extensions extending out from either sides of the liner container to allow user to grab the container for disposal of melted wax. Wherein the base of the liner container serves as an additional tray which can be disposed over the dish of the wax warmer, and the wax cube to be melted can be disposed over the base tray of the liner container of an embodiment of the present invention. While upstanding sidewalls of the liner container provides a barrier for the melted wax to stay within the territory of the liner container and restricts melted wax from being leaked on the dish of the wax warmer.

The liner container according to an embodiment of the present invention wherein the pair of wings/extensions protrude from either sides of the container and are configured such a way that it can radiate beat easily out. Therefore the wings/extensions of the liner container are at lower temperature compared to the base of the container and the dish of the wax warmer, hence allows user to hold the container through the wings/extensions and discard the melted wax quickly so that the dish may be reused immediately.

Another object of the present invention is to provide a liner container for a dish of the wax warmer that is made of material such as, but not limited to, the aluminium foil or thin aluminium sheets that allows conduction of the heat from the heating unit of the wax warmer to the liner container through the dish of the wax warmer for the wax disposed within the liner container to get melted and spread the fragrance according to an embodiment of the present invention.

Yet one another object of the present invention is to eliminate the need of cleaning the wax melt dish after each time it is emptied by providing a liner container on which user can dispose a wax to be melted instead of directly disposing the wax on the warmer dish and replace it with another liner container after one use.

One more object of the present invention is to provide a liner container that is easily and immediately replaceable and also eliminates the need of the user to wait for the wax to get hard to be removed from the dish of the wax warmer by popping out or using some tools that further results in a residue left behind in the dish that is tedious to scrape-off and prevent the dish from being replaced immediately.

Yet one more object of the present invention is to provide liner container that resembles/mimics the shape and size of the dish of the wax warmer, wherein the size is preferably little smaller than the dish with a same shape of the dish for perfect placement of it into the dish of the wax warmer.

### BRIEF DESCRIPTION OF DRAWINGS

Other objects, features, and advantages of the present subject matter will be apparent from the following description when read with reference to the accompanying drawings. Drawings are illustrated with different views according to different embodiments of the invention.

FIG. 1A illustrates liner container that includes base portion, side walls and an extensions extending from the side walls in accordance with an embodiment of the present invention.

FIG. 1B and FIG. 1C illustrates side views of the liner container in accordance with an embodiment of the present invention.

### DETAILED DESCRIPTION OF THE INVENTION

The present invention will now be described in brief with reference to the accompanying drawings. Now, refer in more detail to the exemplary drawings for the purposes of illustrating non-limiting embodiments of the present invention.

As used herein, the term ‘article’ refers to the portable container that is used as a liner over the disk of the wax warmer used for a home fragrance to provide easy and quick disposal of the melted wax from the disk of the said warmer.

According to an embodiment of the present invention, a liner container is placed on the top of the wax warmer which is in configuration with the features that are complementary to the features of open top of the warmer and in which the scented wax is placed and can be melted by the heat of the incandescent light bulb or heating element of the wax warmer. The liner container contains a housing for retaining and receiving the scented wax. The liner container is made up of a material to maintain the temperature similar to the dish of the warmer for disposal of scent therefrom. The top of the liner container is kept open to facilitate the dispersal of the aroma of the wax melt while in the operation of the device.

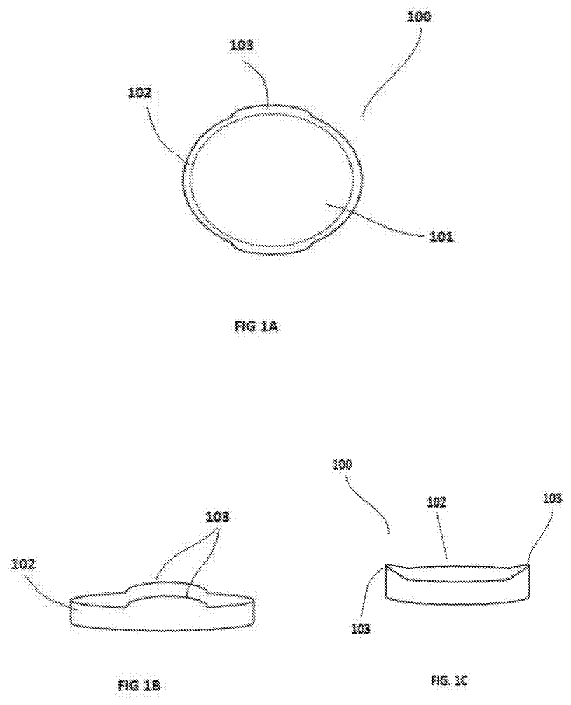

Furthermore, the liner container shown in FIG. 1A through FIG. 1C is generally cylindrical shape. In other embodiments liner containers according to the embodiment of the present invention may have any shape configured to rest upon the top of any candle/wax warmer with flat top or flat dish on the top where the liner container can fit comfortably. Thus, the shape of the liner container can vary upon the shape of the top of the warmer. However, the size of the liner is preferably slightly smaller than the dish of the warmer in which it needs to be placed.

Referring now in more detail to the exemplary drawings for purposes of illustrating embodiments of the invention, wherein like reference numerals designate corresponding or like elements among the several views.

Now referring to FIG. 1A, which is a perspective view of a liner container 100 according to an embodiment of the present invention. The liner container 100 for melting and disposing melted wax of the wax warmer consists of a most preferably, but not limited to, the circular shaped flat base plate 101 and an upstanding side walls 102 all around the circumference of the base 101 which are inclined outwardly from the base. The side walls 102 and base portion 101 together enclosing an interior volume suitable for containing a volume of liquid. The bottom side of the base plate 101 includes rigid, strong surface that can be placed securely on the top of the wax warmer in close proximity of the light bulb or heat source according to the wax warmer. According to an embodiment of the present invention, the liner container further includes a pair of a wings/extensions 103 extending out from either side of the article that allows the user to hold the container without any harm.

In certain form(s) of embodiment, the base 101 of the present invention is made using a foil of metal or using any polymer material with a higher melting point compared to the wax. Hence, it withstands heat generated by the wax warmer while in use for melting the wax inside the liner container 100. In certain form(s) of embodiment, the base portion 101 is made of a thin foil of a metal such as aluminium, copper, tin, steel or polymer etc. The bottom of the planar base plate 101 is a strong and flexible surface that allows placement of the base plate 101 of the liner container 100 on the top surface of the dish of the wax warmer. The shape of the base plate 101 of the liner container 100 can be circular, square, rectangle, or oval. Preferably the shape of the base portion 101 of the liner container 100 is selected according to the shape of the dish of the warmer on which the liner container would be placed for melting the wax. For conformity and better placement of the liner container 100 over the dish of the warmer, the size of the base portion 101 is selected slight smaller than the dish size. Further, the thickness of the base portion 101 of the liner container 100 is between the ranges of 0.25 mm-0.50 mm according to the heating of the wax warmer. Moreover, the thickness can be varied for perfect melting of wax as in the case with low thickness of the base and high temperature of wax warmer will cause the wax to melt down rapidly without properly dispersing fragrance and vice versa.

The side walls 102 are upstanding walls at the circumference of the base portion 101 of the liner container 100 which in combination with base portion 101 forms a structure of a liner container 100 with an interior volume suitable for placing un-melted scented wax cubes or tarts for holding and containing it when it melting. According to one embodiment of an invention, the side walls 102 of the liner container 100 are inclined outwardly with an outwardly extending rim (not shown) at the ends of the wall. While the height of the side walls 102 is between the ranges of 0.5 cm-5 cm for enclosing interior volume suitable for containing a volume of melted wax.

The extensions 103 are a pair of wings extends out from two opposite sides of the side walls 102 of the liner container according to an embodiment of the invention that allows user to grab the liner container 100 for disposal of melted wax. The shape of the wings/extension can be oval, rectangular or square with a size that allow easy grip to the hand of the user. The thickness of the extensions 103 can be same or can be twice than the thickness of the base portion 101 of the liner container 100 thus the wings/extensions 103 easily dissipates the heat out of it, thereby making it cooler compared to the other parts of the liner container 100 thus allows the user to grab and hold it using bare hands.

FIG. 1B and FIG. 1C, illustrates the side views of a liner container 100 according to present embodiment of the invention that shows the side walls 102 working as a container for the melted wax. Thus, the molten wax is contained and does not overflow or leak from the said liner container 100 and also shows a pair of wings/extensions configured at the ends of the side walls 102 and extending out from either side of the liner container 100.

1. A liner container for melting scented wax and disposing melted wax comprising:
a planar base for containing scented wax,
an upstanding side wall around the circumference of the planar base; and
a pair of wings protruding from two portions of the wall configured to allow user to hold the container and dispose the melted wax from the liner container.

2. The liner container according to claim 1, wherein the side wall together with the planar base forms a cylindrical housing of the liner container with an interior volume suitable for enclosing volume of melted wax.

3. The liner container according to claim 1, wherein the base is sized and configured to fit within and rest upon the dish of the wax warmer in such a way that the wax can be melted within the container when the base is placed over top surface of the dish of the wax warmer.

4. The liner container according to claim 1, wherein the base, the side walls and the wings are made as a single unit.

5. The liner container according to claim 1, wherein the wings are facing each other symmetrically.

6. The liner container according to claim 1, wherein the container is made of heat conducting polymers.

7. The liner container according to claim 1, wherein the container is made of a foil or sheet of metal.

8. The liner container according to claim 7, wherein the metal for the liner container is selected from a group consisting of aluminium, copper, tin, brass, lead or alloys of metals.

9. The liner container according to claim 1, wherein the thickness of the base is in a range between 0.25 mm to 0.50 mm.

10. The liner container according to claim 1, wherein the shape of the liner container is any geometric shape such as circle, cylindrical, rectangle, oval, square or any special shape that conforms the shape of the dish of the wax warmer.

11. The liner container according to claim 1, wherein the size of the liner container is variable enough to accommodate dish of the wax warmer.

12. The liner container according to claim 1, wherein the thickness of the wings is same as the thickness of the base.

13. The liner container according to claim 1, wherein the shape of the wings is any geometric shape such as the oval shape, rectangular shape or the square shape with a size that allows easy grip to user.

14. The liner container according to claim 1, wherein the liner container is disposable.

15. The wax warmer system, comprising:
a wax warmer comprising:
a housing with a base including one of a heat source for heat generation; and
a dish of the wax warmer configured for placing the liner container within it and to transfer heat from the source to the liner container during the operation of the wax warmer;
a liner container as claimed claim 1, disposed over top surface of the dish of the wax warmer separating wax from the dish of the wax warmer; and
a scented wax to be melted placed within the liner container that allows disposal of melted wax.

16. The wax warmer system according to claim 16, wherein the liner container is disposable container comprising a base, side wall and a pair of wings.

17. The wax warmer system according to claim 16, wherein the liner container is disposed within the dish of the wax warmer such that the entire bottom surface of the base of the liner container is in contact with the upper surface of the dish.
